(19) United States
(12) Patent Application Publication
(10) Pub. No.: US 2005/0270572 A1
(43) Pub. Date: Dec. 8, 2005

(54) System and method for virtual print devices for command implementation

(75) Inventor: Peter Kassan, Dobbs Ferry, NY (US)

Correspondence Address: OSTROLENK FABER GERB & SOFFEN, 1180 AVENUE OF THE AMERICAS, NEW YORK, NY, 100368403, US

(73) Assignee: Web Bindery LLC

(21) Appl. No.: 11/199,358

(22) Filed: Aug. 8, 2005

Related U.S. Application Data
(63) Continuation-in-part of application No. 11/193,716, filed on Jul. 29, 2005.
Application No. 11/193,716 is a continuation-in-part of application No. 10/671,194, filed on Sep. 25, 2003.
(60) Provisional application No. 60/460,352, filed on Apr. 3, 2003.
(60) Provisional application No. 60/599,519, filed on Aug. 6, 2004.

(51) Int. Cl. G06F 15/00

(52) U.S. Cl. 358/1.15

(57) ABSTRACT

The invention comprises a system and method for executing a first command in a software application. In a preferred embodiment, a virtual printer device is installed on a computing device that operates the software application. The virtual printer device is selected in the computing device for printing, and a second command to print content in the software application is issued by a user and received by the computing device. The first command is executed on the computing device as a function of receiving the second command to print the content.

### CROSS-REFERENCE TO RELATED APPLICATION

This patent application is a continuation-in-part of U.S. patent application Ser. No. 11/193,716 filed Jul. 29, 2005 and entitled IMPROVED SYSTEM AND METHOD FOR PROVIDING FORMATTED PRINT PAGES, which is a continuation-in-part of Ser. No. 10/671,194 filed Sep. 25, 2003 and entitled SYSTEM FOR PRODUCING ONLINE CONTENT FROM WEB SITES ON DEMAND, which claims priority to U.S. Provisional Patent Application Ser. No. 60/460,352, filed on Apr. 3, 2003 and entitled “SYSTEM FOR PRODUCING MAGAZINES FROM WEB SITES ON DEMAND,” and is further based on and claims priority to U.S. Provisional Patent Application Ser. No. 60/599,519, filed on Aug. 6, 2004 and entitled “SYSTEM AND METHOD FOR VIRTUAL PRINT DEVICES FOR COMMAND IMPLEMENTATION,” the entire contents of all of which are hereby incorporated herein by reference.

### BACKGROUND OF THE INVENTION

1. Field of the Invention

The present invention relates generally to computing devices and, more particularly, to issuing commands to a processor.

2. Description of the Related Art

Various systems are known for issuing and executing commands in computer software applications. For example, graphical screen controls, such as buttons, drop-down lists, check boxes, radio buttons, text fields or the like, when selected, cause instructions to be issued to a processor that bring about desired results. Additionally, many software applications provide options in the form of menus that enable users to issue software commands.

The majority of commercial software applications provide options to output electronic content to a printer: Typically, after a user installs a printer, the user selects a command in a software (e.g., word processing, database, spreadsheet, and/or image editing software) to print to the printer.

Many internet web sites provide electronic content that users desire to have in printed form. For example, a user via a web browser software application views an article on an internet web site, and selects a control (such as button) in the web browser application to print the article on his locally-installed printer. In another example, graphical screen controls are included on web pages that, when selected cause print commands to be issued to the user's printer. In another context, a web site provides users with a list of documents that are stored on the internet web site and the user can select an item in the list to print. In yet another context, users submit information in some web-based data entry form, and the users print the information in the form for future reference.

Thus, users of computing devices have many needs for outputting electronic content to a printer. Referring to the drawings in which like reference numerals refer to like elements, FIG. 1 shows an example prior art hardware arrangement for viewing, reviewing and outputting internet web site content. As shown in FIG. 1, an internet web server 2 provides electronic content 3 to a user terminal 4 that communicates with the web server 2 via communication network 16. Content 3 includes, for example, text, graphics, pictorial, audio and video material. The user terminal 4 preferably employs software that enables a communication session to be established between the user terminal 4 and the web server 2. Preferably, the web server 2 employs software enabling a communication session, for example an HTTP session, to be established between the user terminal 4 and the web server 2. Also as shown in FIG. 1, a printer 7 is preferably controlled by user terminal 4 to provide printed output of content 3. For example, after a person views content 3 on user terminal 4 using typical web browser software, the person selects an option to print the content 3 on printer 7.

Co-pending U.S. patent applications Ser. Nos. 10/671,194 and 11/193,716, assigned to the assignee of the present invention, describe a system and method for providing formatted print pages of electronic content. In one embodiment, a request is received for formatted print pages related to content provided one or more internet web sites. After the request is received, a layout is applied for the content and electronic production information representing instructions for fulfilling the request is transmitted to a fulfillment facility where the formatted print pages are generated and delivered to the requestor. In another embodiment, the electronic content is stored on the user's hard drive or over a private network.

In one known system, ADOBE SYSTEMS, INC. distributes a printer driver (“PDFWRITER”) that enables users to select and print to a device that is not a physical printer. When a user prints to the PDFWRITER, an electronic file formatted in the PORTABLE DOCUMENT FORMAT (“PDF”) is automatically generated. Thus, the PDFWRITER is a printer driver that converts files directly to PDF from another software application.

As described in co-pending U.S. patent application Ser. No. 10/671,194, one or more controls may be provided for requesting formatted print pages. For example, a button may be included in a graphical user interface that, when selected, enable the user to prepare and/or submit the request. In this example, the control must be added to the interface to enable the request to be processed.

Adding a control in the interface is often viewed as undesirable for various reasons. For example, additional software must be provided that enable the button (or other screen control) to enable a user to request formatted print pages. The software must be compatible with an existing application, and a skilled software programmer or other technically proficient individual may be required to integrate the control into existing software.

Moreover, a graphic artist may design an elegant software graphical user interface. The addition of a button to the interface can be viewed as tarnishing or otherwise diminishing the appearance of the interface.

Therefore, a need exists in the industry for an improved way to enable users to issue commands to a processing device, without the need for integrating controls and associated software in an existing software application.

### SUMMARY OF THE INVENTION

The present invention addresses these and other shortcomings in the prior art by improving the way commands and/or instructions are integrated in software applications.

In a preferred embodiment, the present invention enables a user to issue commands, for example, to an information processor to perform a variety of functions by enabling a user to issue a simple print command. In a preferred embodiment, a user installs a virtual printing device. When a user issues a command to print to the virtual printing device, the print command is preferably intercepted, for example, by a virtual print driver and one or more commands, possibly unrelated to printing, are executed.

In another embodiment of the invention, a plurality of virtual printers are installed, each representing one or more commands that are issued to perform one or more respective tasks.

Thus, the invention comprises a system and method for executing a first command in a software application. In a preferred embodiment, a virtual printer device is installed on a computing device that operates the software application. The virtual printer device is selected in the computing device for printing, and a second command to print content in the software application is issued by a user and received by the computing device. The first command is executed on the computing device as a function of receiving the second command to print the content.

Other features and advantages of the present invention will become apparent from the following description of the invention which refers to the accompanying drawings.

### BRIEF DESCRIPTION OF THE DRAWINGS

For the purposes of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 shows an prior art hardware arrangement for viewing, reviewing and outputting internet web site content;

FIG. 2 shows an example hardware arrangement in a preferred embodiment of the present invention;

FIG. 3 illustrates the functional elements of a user terminal;

FIGS. 4A, 4B and 4C are example display screens illustrating steps associated with installing a virtual print device in accordance a preferred embodiment of the present invention; and

FIG. 5 is a flowchart illustrating example steps associated with generating a request for formatted print pages in accordance with the preferred embodiment of the present invention;

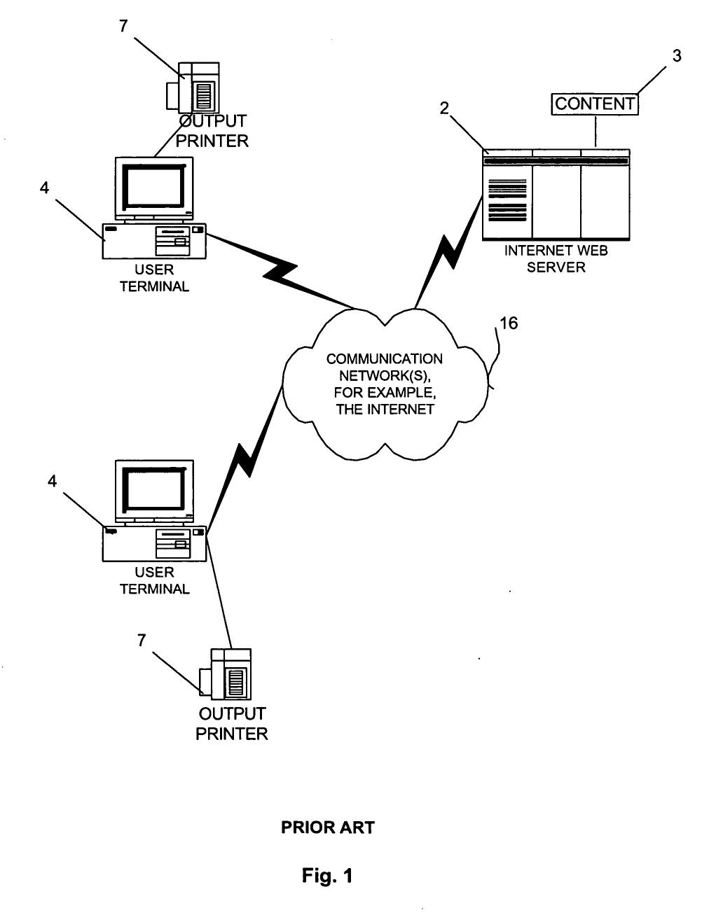

### DESCRIPTION OF THE PREFERRED EMBODIMENT

The present invention improves the way commands and/or instructions are integrated in software applications. In a preferred embodiment, a virtual print device is installed on a computer in substantially the same way that any printing device (e.g., EPSON printer, HEWLETT-PACKARD printer, etc.) is installed. Thereafter, when a print command is issued to the virtual print device, the print command is intercepted, for example at the operating system level, and one or more commands are executed.

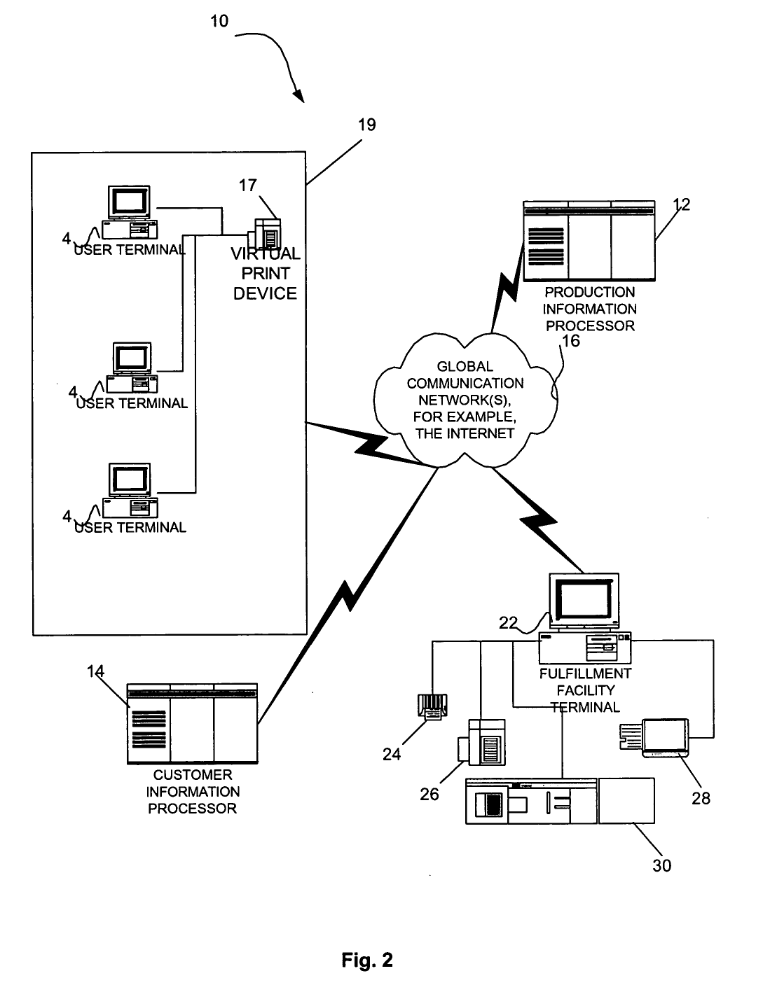

FIG. 2 shows an example hardware arrangement in a preferred embodiment of the present invention, including a hardware arrangement for providing formatted print pages, and referred to generally as system 10. The electronic content for the formatted print pages may be web-based, as described in co-pending U.S. patent application Ser. No. 10/671,194, or, alternatively, may be from content stored on a so-called locally installed drive or over a private network. In the embodiment shown in FIG. 2, system 10 comprises at least one production information processor 12, and at least one customer information processor 14 and adapted to access communication network 16. Each of the production information processor 12 and the customer information processor 14 preferably provide respective internet web sites that includes content information for respective visitors, substantially as described in co-pending U.S. patent application Ser. No. 10/671,194.

Also as shown in FIG. 2, a fulfillment facility terminal 22 communicates with at least the production information processor 12 and receives instructions with respect to a request for printed content. Although the embodiment shown in FIG. 2 identifies the fulfillment facility terminal 22 separate from the production information processor 12, the fulfillment facility terminal 22 can be under the direct control of the proprietor of the production information processor 12.

In the example shown in FIG. 2, fulfillment facility terminal 22 preferably includes a formatted print output printer 24. In addition to the formatted print output printer 24, one or more other devices are preferably provided and used in accordance with the present invention. For example, a fulfillment facility terminal 22 employs a binding machine 28 to combine individual sheets. Further, a saddle stitch machine 30 may be provided to provide a professional appearance for the printed output. Further, a folding machine 26 may be employed by the fulfillment facility terminal 22 in order to prepare signatures, i.e., sets of one or more sheets for binding. As shown in FIG. 2, the output related devices, including, the folding machine 26, binding machine 28, and saddle stitch machine 30 are presented as separate and apart from the formatted print output printer 24. Of course, one skilled in the art will recognize that two or more of these devices may be integrated into a single device.

In the preferred embodiment, user terminals 4 are situated on private network 19 using any known data communication networking technology. Private network 19 is preferably connected to global communication network 1. Production information processors 12 and customer information processors 14 are coupled to communication network 16.

Virtual printer device 17 operates in accordance with the teachings herein and can be installed as a network printer (i.e., shared among user terminals 4 as shown in the example embodiment shown in Fig. 2) or, alternatively, can be installed on an individual system. User terminals 4, production information processor 12 and customer information processor 14 are any devices that are capable of sending and receiving data across communication network 16, e.g., mainframe computers, mini computers, personal computers, laptop computers, a personal digital assistants (PDA) and internet access devices such as Web TV. In addition, production information processors 12 and customer information processors 14 are preferably equipped with a web browser, such as MICROSOFT INTERNET EXPLORER, NETSCAPE NAVIGATOR and the like.

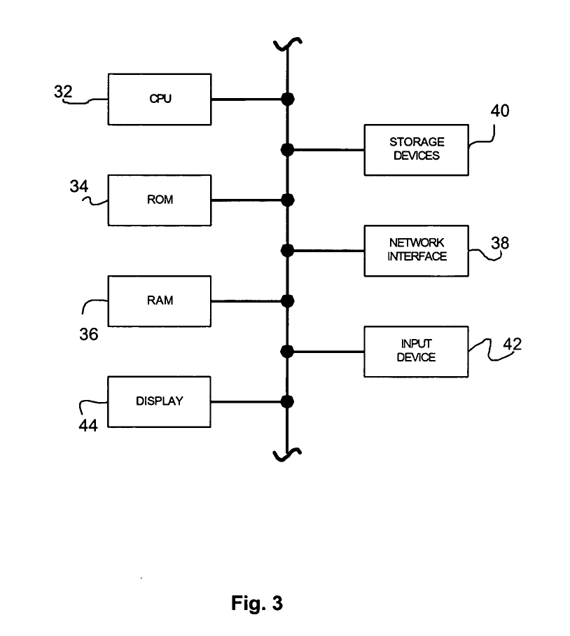

FIG. 3 illustrates the functional elements of user terminal 4, production information processor 12 and/or customer information processor 14 and include one or more central processing units (CPU) 32 used to execute software code and control the operation of user terminal 4, read-only memory (ROM) 34, random access memory (RAM) 36, one or more network interfaces 38 to transmit and receive data to and from other computing devices across a communication network, storage devices 40 such as a hard disk drive, floppy disk drive, tape drive, CD ROM or DVD for storing program code, databases and application data, one or more input devices 42 such as a keyboard, mouse, track ball, microphone and the like, and a display 44.

The various components of user terminal 4 need not be physically contained within the same chassis or even located in a single location. For example, storage device 40 may be located at a site which is remote from the remaining elements of production user terminal 4, and may even be connected to CPU 32 across communication network 16 via network interface 38. Production information processor 12 preferably includes a memory equipped with sufficient storage to provide the necessary databases, forums, and other community services as well as acting as a web server for communicating hypertext markup language (HTML), Java applets, Active-X control programs or the like to customer information processors 14. Production information processors 12 are arranged with components, for example, those shown in FIG. 3, suitable for the expected operating environment of production information processor 12. The CPU(s) 32, network interface(s) 38 and memory and storage devices are selected to ensure that capacities are arranged to accommodate expected demand.

The nature of the present invention is such that one skilled in the art of writing computer executable code (i.e., software) can implement the described functions using one or more of a combination of popular computer programming languages and developing environments including, but not limited to C, C++, Visual Basic, JAVA, HTML, XML, ACTIVE SERVER PAGES, JAVA server pages, servlets, and a plurality web site development applications.

It is contemplated herein that any suitable operating system can be used on user terminal 4, production information processor 12 and customer information processor 14, for example, DOS, WINDOWS 3.x, WINDOWS 95, WINDOWS 98, WINDOWS NT, WINDOWS 2000, WINDOWS ME, WINDOWS CE, WINDOWS POCKET PC, WINDOWS XP, MAC OS, UNIX, LINUX, PALM OS POCKET PC and any other suitable operating system.

As used herein, the term, “module” refers, generally, to one or more discrete components that contribute to the effectiveness of the present invention. Modules can operate or, alternatively, depend upon one or more other modules in order to function.

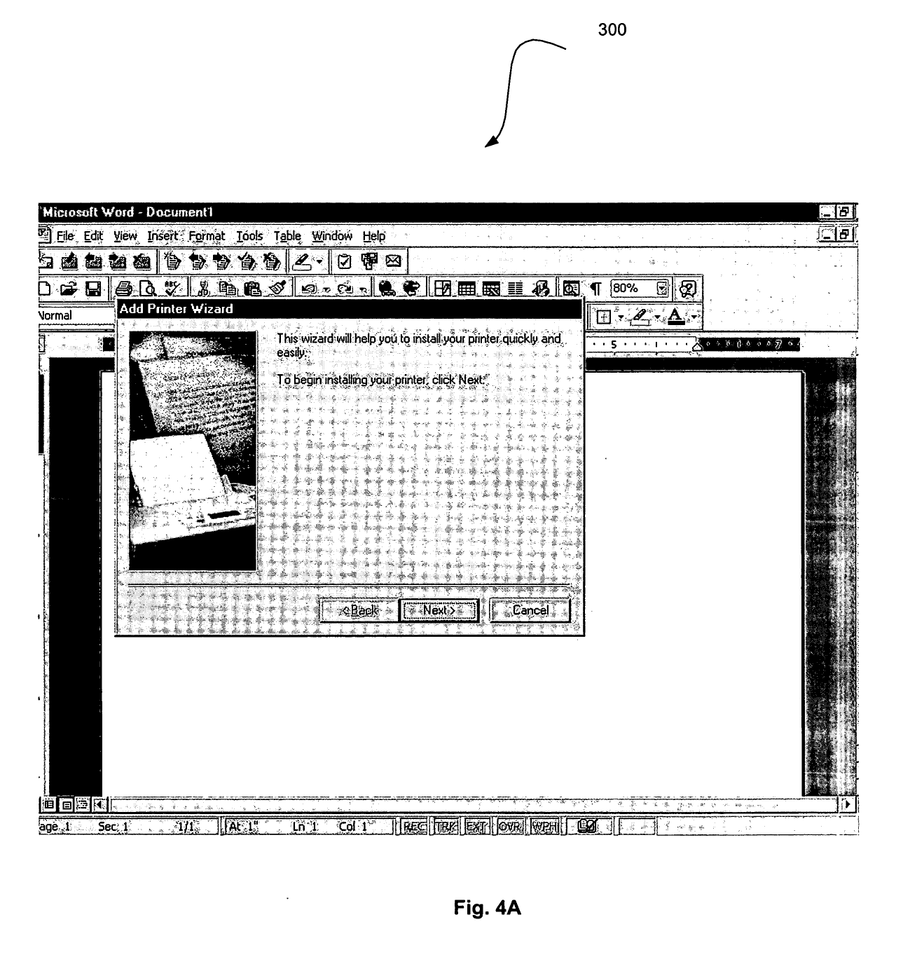

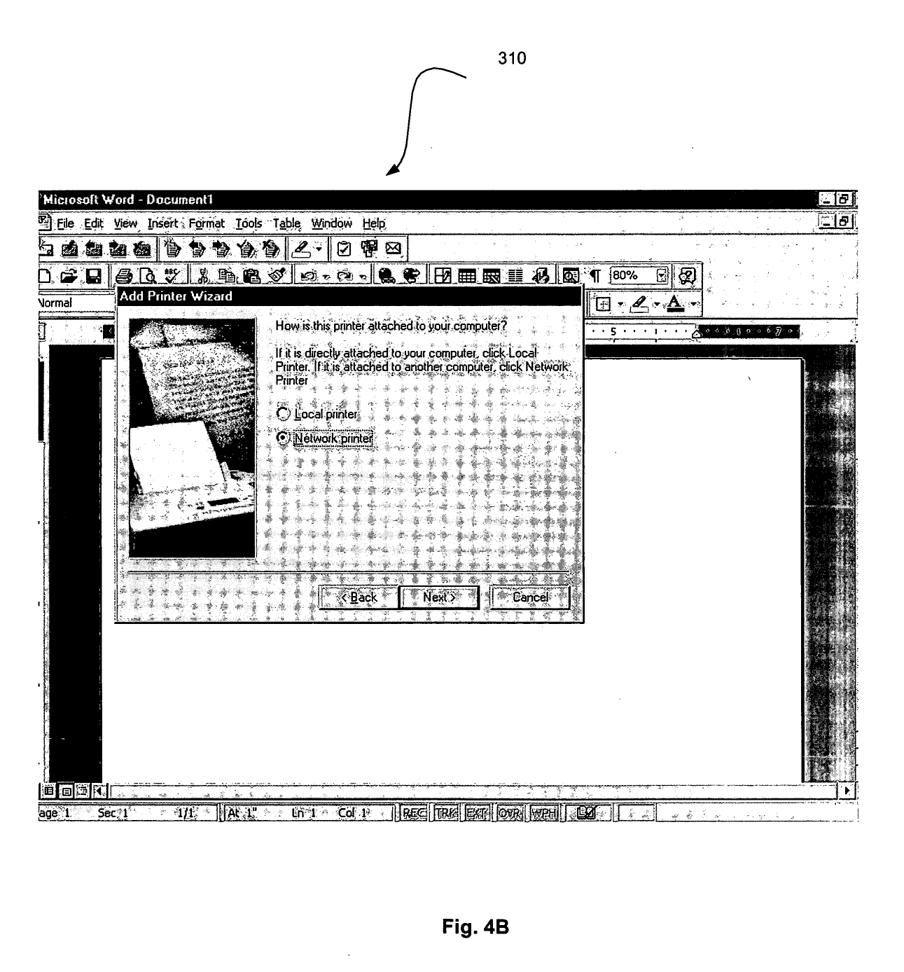

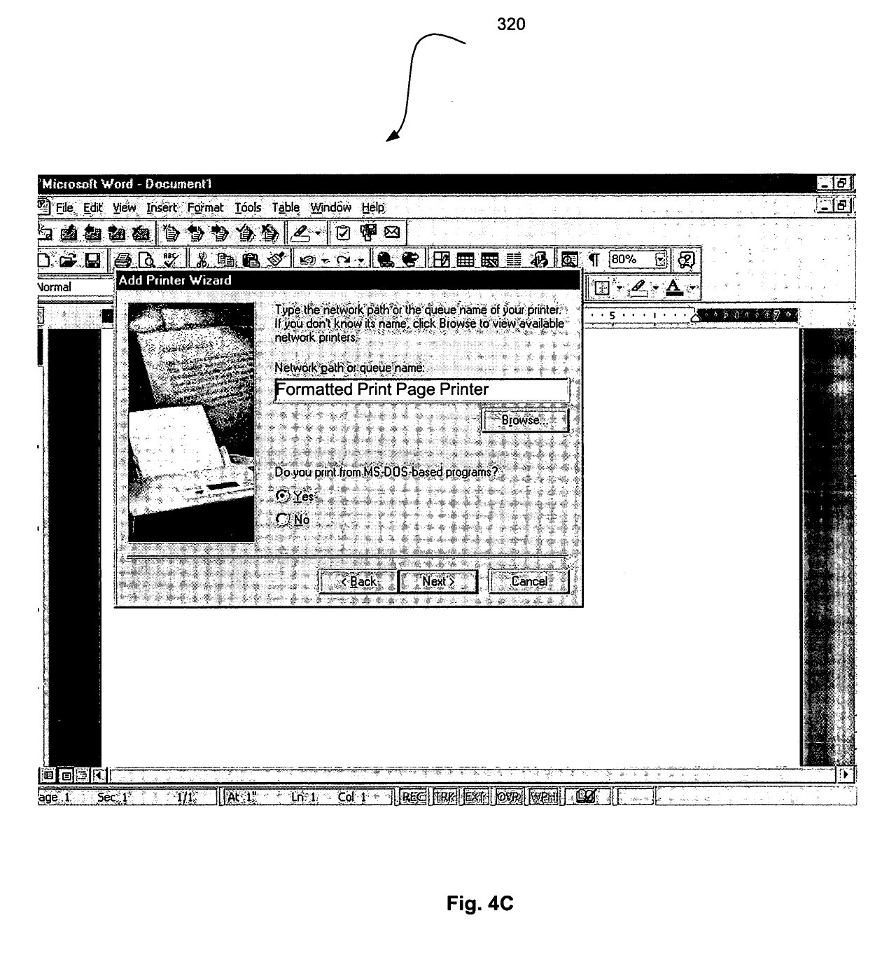

FIGS. 4A, 4B and 4C are example display screens illustrating steps associated with installing a virtual print device 17 in accordance a preferred embodiment of the present invention. In the example shown in FIGS. 3A-3C, the virtual print device 17 is configured as a network printer via the MICROSOFT WINDOWS operating system.

FIG. 4A illustrates a display screen 300 in which the virtual print device 17 is installed via the MICROSOFT WINDOWS operating system. The virtual print device 17 FIG. 4B shows a display screen 310 in which the virtual print device 17 being installed as a network printer. As noted above, one skilled in the art will recognize that a local printer can be defined as well for a virtual printer in accordance with the teachings herein.

FIG. 4C illustrates a display screen 320 in which the newly added virtual printer device 17 is entitled “Formatted Print Page Printer.” The Formatted Print Page Printer is selectable by the user in order to issue print commands thereto. In one embodiment of the present invention, the Formatted Print Page Printer device 17 will use a virtual driver that is operative to intercept an operating system level print command, and issue command(s) to perform one or more tasks. The virtual driver can be distributed via any suitable form or medium, such as a CD-ROM, or, alternatively, can be retrieved from an on-line source, such as an internet web site.

In accordance with a preferred embodiment, when a user sends a command to print to the installed device 17, the print command is intercepted, for example, by the virtual driver, and one or more command(s) associated with the virtual printer are executed.

For example, a user installs a virtual printer that is operative to display a data entry form for transmitting a request for formatted print pages. The user, using a standard web browser software application, establishes a communication session with a web site that includes content the user desires to have output as formatted print pages. Accordingly, the user selects an icon in the web browser software to initiate printing, and the user selects the virtual printer, Formatted Print Page Printer, from a drop-down list of available printers. The user then selects a graphic button labeled OK to send the print command.

Continuing with the above example, the print command issued by the user is intercepted by a virtual print driver and a command associated with the virtual printer is issued to display the data entry form for requesting formatted print pages. The user proceeds to submit information regarding the particular content desired for the formatted print pages, a preferred layout, page size, binding type, and the like. Moreover, payment and delivery information is preferably submitted in the data entry form. Thereafter, the user selects a graphic control, for example, a button labeled OK, and the information provided by the user in the data entry is transmitted to for eventual fulfillment. Examples and descriptions of information submitted by the user, and of options provided by the present invention are provided in greater detail in co-pending U.S. patent applications Ser. Nos. 10/671,194 and 11/193,716.

The present invention can be used in many contexts as a convenient system and method to issue one or more commands to one or more computing devices. For example, various web sites request information from a user, such as to register for access to content. Using the present invention, the user can simply print to the virtual printing device 17 and predefined information can be transmitted automatically to the requesting site. Alternatively, a data entry form can be presented to the user in which information can be provided and transmitted to a database. In one embodiment of the present invention, the data is formatted, for example, as an XML document prior to being transmitted to a receiving device. In this way, users can transmit information easily and be assured that the data they transmit will be formatted properly and in accordance with various predefined configurations.

In another embodiment of the present invention, a plurality of virtual printers can be installed, each representing a particular context of use. For example, a first database application may require data received from a user to be formatted such that the user's last name is provided prior to a user's first name. A second database application may require the same data to be formatted such that the user's first name to be received prior to a user's last name. Accordingly, two virtual print devices 17 can be installed to accommodate the various requirements of the databases. Of course, one skilled in the art will recognize that the above example is merely illustrative, and that the present invention can support countless data formatting and other requirements by receiving systems. For example, data may be configured as an MICROSOFT EXCEL spreadsheet file, as a comma delimited ASCII text file, as a MICROSOFT SQL SERVER table file, or the like. In another embodiment, data may be formatted as in image file (e.g., TIFF, JPG, BMP, GIF, or the like). In yet another embodiment, data may be stored in an ADOBE ACROBAT PDF file. In any one or plurality of contexts, a plurality of virtual print devices 17 can be installed and selected to provide data to accommodate receiving systems.

As noted above, in accordance with the teachings herein, a web site can provide one or more virtual print drivers which are downloadable to users. Using a simple print command in any software application, for example, a web browser software application, an image editing software application or a word processing software application, users can issue one or more commands to carry out various functions. For example, using a single print command, a request for formatted print pages can be made substantially automatically, for example, to assure that requests are properly configured, formatted and/or received.

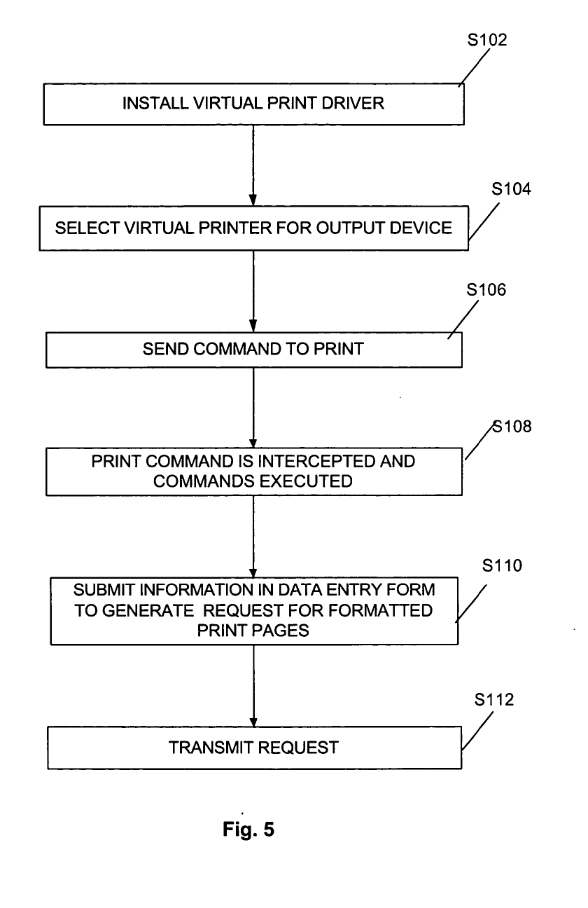

FIG. 5 is a flowchart illustrating example steps associated with generating a request for formatted print pages in accordance with the preferred embodiment of the present invention. In step S102, a user installs a virtual print driver for the virtual print device 17. As described above, the driver may be received and/or distributed from any suitable media (e.g., floppy disc, CD-ROM disc or DVD), or may be downloaded via a network connection. After the virtual print driver is installed, the user selects the virtual print device 17 for the output device (step S104). When the device 17 is selected as the output device, then a command is issued by the user to print electronic content (step S106). For example, the user may select a print icon in a web browser software application, may select menu choices (e.g., “File, Print”), or may select an icon of a printer in a spreadsheet software application. Any suitable manner of issuing a print command in any software application is envisioned herein as initiating a command to print.

Continuing with the flowchart shown in FIG. 5, after the print command is sent, the command is intercepted, for example at the operating system level, and one or more commands are executed (step S108). For example, a dialogue box may be displayed for the user to indicate that a request for formatted print pages is being generated. Alternatively, a data entry display form may be provided to receive payment information from the user. Of course, one skilled in the art will recognize that these are two non-limiting examples, and that practically any commands can be issued and executed in accordance with the teachings herein in step S108. In accordance with the example flowchart in FIG. 5, the user has installed a virtual print device 17 for requesting formatted print pages. Thus, in step S110, the user submits information in a data entry form to generate format print pages. In step S112, the user transmits the request, for example by pressing a graphic screen control formatted as windowed button. The request is preferably received and processed, substantially as described in co-pending U.S. patent applications Ser. No. 10/671,194.

Thus, the present invention provides a new way to provide commands, such as requests for formatted print pages, using a virtual print device 17. The present invention provides benefits over prior art systems for initiating commands. No additional software controls and related software need to be integrated into existing software application. As noted above, integrating controls and related software is problematic. Often, skilled programmers are required to integrate custom controls into software, which increases costs and time. Further, display screen layouts are often negatively impacted by the addition of graphical screen controls provided by third parties. Moreover, integrating software functionality from a third party into an existing software application is, typically, applicable only for that existing software application. For example, providing a graphical screen control for additional functionality in a word processing application is applicable only for that word processing application.

The present invention improves upon prior art systems by improving the ways commands are issued in existing software. By providing a virtual print device 17, additional screen controls and commands do not have to be programmed into an existing software application. Instead, a user simply prints to the virtual print device 17, and one or more commands are issued automatically. Further, any software that provides printing functionality can use the functionality provided by the present invention. In other words, the present invention is not application-specific.

In a particular (non-limiting) example, the present invention improves ways for users to request formatted print pages of electronic content provided over the internet, or stored either locally or over a private network.

Other uses and products provided by the present invention will be apparent to those skilled in the art. Although the present invention has been described in relation to particular embodiments thereof, many other variations and modifications and other uses will become apparent to those skilled in the art. It is preferred, therefore, that the present invention not be limited by the specific disclosure herein.

1. A method for executing a first command in a software application, the method comprising:
installing a virtual printer device on a computing device that operates the software application;
selecting on the computing device the virtual printer device for receiving a second command to print content in the software application;
issuing on the computing device the second command to print content in the software application;
receiving by the computing device the second command to print; and
executing the first command on the computing device as a function of receiving the second command to print.

2. The method of claim 1, further comprising:
issuing a third command to print content in another software application;
receiving by the computing device the third command to print; and
executing the first command on the computing device, wherein the computing device executes the first command as a function of receiving the third command to print.

3. The method of claim 1, further comprising intercepting the second command to print and executing the first command as a function of the step of intercepting.

4. The method of claim 1, further comprising requesting formatted print pages by a user of the computing device as a function of the first command.

5. The method of claim 1, wherein the step of requesting comprises:
providing a data entry form operable to receive input from the user;
receiving from a user of the computing device electronic order information for formatted print pages;
processing the electronic order information to provide electronic production information representing instructions for fulfilling the request;
transmitting the electronic production information to a fulfillment facility; and
providing to the user the requested web hosted information from the fulfillment facility in the form of printed pages.

6. The method of claim 5, wherein the software application is a web browser software application.

7. The method of claim 1, further comprising:
installing a second virtual printer device on the computing device;
selecting by the user on the computing device the second virtual printer device for receiving a third command to print content in the software application;
issuing by the user on the computing device the third command to print;
receiving by the computing device the third command to print; and
executing a fourth command on the computing device, wherein the computing device executes the fourth command as a function of receiving the third command to print.

8. The method of claim 1, wherein the first command includes modifying electronic information received by a user of the computing device to comply with a data format.

9. The method of claim 8, wherein the data format is at least one of an XML file, an ASCII text file, an HTML file, a MICROSOFT EXCEL file, a MICROSOFT SQL SERVER compatible table file, an image file, and a PDF file.

10. The method of claim 1, wherein the step of installing virtual printer device includes installing a virtual printer device driver for the virtual printer device.

11. The method of claim 10, wherein the virtual printer device driver is provided on an internet web site and is downloadable to computing devices.

12. A system for enabling a first command to be executed in a software application, the system comprising:
a virtual printer device installed on a computing device that operates the software application;
a printer selection interface operable on the computing device enabling a user to select the virtual printer device for issuing a print command via the computing device;
a print content interface operable in the software application enabling a user to issue a second command to print content in the software application, wherein the first command is executed on the computing device as a function of the second command.

13. The system of claim 12, further comprising a virtual printer device driver for the virtual printer device.

14. The method of claim 13, wherein the virtual printer device driver is provided on an internet web site and is downloadable to computing devices.

15. The system of claim 12, further comprising a formatted print page request interface enabling a user of the computing device to request formatted print pages, wherein the formatted print page request interface is provided to a user of the computing device after the second command is received by the computing device.

16. The system of claim 12, wherein the formatted print page request interface comprises:
a data entry form operable to receive electronic order information for formatted print pages from the user;
an electronic order information processing module to provide electronic production information representing instructions for fulfilling the request;
a communication interface enabling transmission of the electronic production information to a fulfillment facility that provides to the user the requested web hosted information from the fulfillment facility in the form of printed pages.

17. The method of claim 16, wherein the software application is a web browser software application.

18. The system of claim 12, wherein the first command modifies electronic information received by a user of the computing device to comply with a data format.

19. The method of claim 18, wherein the data format is at least one of an XML file, an ASCII text file, an HTML file, a MICROSOFT EXCEL file, a MICROSOFT SQL SERVER compatible table file, an image file, and a PDF file.

20. A method for providing formatted print pages to a user over a communication network, the method comprising:
providing a virtual printer device to be installed on a computing device that operates a software application;
selecting on the computing device the virtual printer device for receiving a command to print content in the software application;
issuing on the computing device the command to print content in the software application;
receiving by the computing device the command to print;
providing a data entry form operable to receive input from the user as a function of the step of receiving the command to print;
receiving from a user of the computing device electronic order information for formatted print pages;
processing the electronic order information to provide electronic production information representing instructions for fulfilling the request;
transmitting the electronic production information to a fulfillment facility; and
providing to the user the requested web hosted information from the fulfillment facility in the form of printed pages.
